(19) United States
(12) Patent Application Publication
(10) Pub. No.: US 2025/0161981 A1
(43) Pub. Date: May 22, 2025

(54) FIREARM SUPPRESSOR WITH EXTERNAL SURFACE TREATMENT AND METHOD OF MANUFACTURE

(71) Applicant: Bradford Whittam Riley, Olathe, KS (US)

(72) Inventor: Bradford Whittam Riley, Olathe, KS (US)

(21) Appl. No.: 18/956,514

(22) Filed: Nov. 22, 2024

Related U.S. Application Data
(63) Continuation of application No. 18/598,685, filed on Mar. 7, 2024.
(60) Provisional application No. 63/451,561, filed on Mar. 11, 2023.

(51) Int. Cl. B05D 5/02; C04B 35/622; F41A 21/02

(52) U.S. Cl. CPC B05D 5/02; C04B 35/62222; F41A 21/02; B05D 2254/02

(57) ABSTRACT

A method of manufacturing a firearm component comprising providing a body has an exterior surface, applying a first coating layer to the exterior surface, after coating the exterior surface affixing a granular aggregate to the exterior surface; and after affixing the aggregate, applying an additional coating layer. The method may include wrapping a mesh about the body.

### CROSS-REFERENCE TO RELATED APPLICATIONS

This application is a continuation-in-part of U.S. patent application Ser. No. 18/598,685, filed on Mar. 7, 2024, entitled “ENHANCED THERMAL COATING (FROG SKIN) FOR MUZZLE DEVICES”, which claims the benefit of U.S. Provisional Patent Application No. 63/451,561, filed on Mar. 11, 2023, entitled “ENHANCED THERMAL COATING (FROG SKIN) FOR MUZZLE DEVICES”, which are hereby incorporated by reference in their entirety for all that is taught and disclosed therein.

### FIELD OF THE TECHNOLOGY

The present embodiment relates to firearm suppressors, specifically thermal coatings for firearm sound suppressors and other firearm parts and accessories.

### BACKGROUND AND SUMMARY

Sound suppressors attached to firearms offer many benefits to a shooter, but the nature of their construction often causes difficulty to the end user. Their conventional cylindrical design and metal or carbon fiber composition results in a smooth surface. This conventional surface is often covered in a thin coating such as paint to improve aesthetics, durability, and thermal control. However, the surface nevertheless subjects the end user to difficulties with frictional engagement with the suppressor, heat dissipation, and visibility due to being a smooth, thin layer of coating.

The conventional, smooth surface makes acquiring a proper grip on the suppressor difficult for operations such as mounting or dismounting the suppressor from the firearm either by hand or by utilizing an instrument.

Because suppressors experience an extreme amount of heat during the discharge of ammunition from the firearm, the conventional surface further results in heat being dissipated outwardly. This causes additional difficulties for the user. Not only would the user experience difficulties in removing the suppressor until it cools down, the hot surface poses a danger should it make contact with clothing or bare skin.

The paint or coatings currently used can often result in light being reflected off the suppressor, giving away a user's position to an enemy.

Some solutions to the issue with grip and heat dissipation have included a covering over the suppressor. Wraps made of cloth material or silicon sleeves have been utilized for decades, but add excessive weight and bulk, and cover only a part of the suppressor.

Another solution is to use a thick, ceramic, high temperature paint. However, this approach can often lead to cracking and peeling.

The above problems are addressed by the present embodiment, and others like it, of a method of manufacturing a firearm component comprising of providing a body has an exterior surface, applying a first coating layer to the exterior surface, and then affixing a granular aggregate to the exterior surface. After affixing the aggregate, an additional coating layer is applied.

### BRIEF DESCRIPTION OF THE DRAWINGS

FIG. 1A is an angled view of a method of manufacture of a suppressor.

FIG. 1B is a side view of a method of manufacture of a suppressor.

FIG. 1C is a partial side-section view of a method of manufacture of a suppressor.

FIG. 1D is a cross-section view of a method of manufacture of a suppressor.

FIG. 1E is detailed view a cross-section view of a method of manufacture of a suppressor.

FIG. 2A is a side view of a method of manufacture of a suppressor showing different stages of the application process.

FIG. 2B is a side section view of a method of manufacture of a suppressor in FIG. 2A.

FIG. 2C is a side section view of the surface of the suppressor in FIG. 2A.

FIG. 3A is a side view of a suppressor that has only the base surface.

FIG. 3B is a side section view of the suppressor of FIG. 3A.

FIG. 3C is a detailed view of a part of the suppressor of FIG. 3A.

FIG. 3D is a cross-section view of the suppressor of FIG. 3A.

FIG. 3E is a detailed view of a part of the suppressor of FIG. 3D.

FIG. 4A is a side view of a suppressor that has a first coating layer applied to its surface.

FIG. 4B is a side section view of the suppressor of FIG. 4A.

FIG. 4C is a detailed view of a part of the suppressor of FIG. 4A.

FIG. 4D is a cross-section view of the suppressor of FIG. 4A.

FIG. 4E is a detailed view of a part of the suppressor of FIG. 4D.

FIG. 5A is a side view of a suppressor that has a mesh layer over a first coating layer over its surface.

FIG. 5B is a side section view of the suppressor of FIG. 5A.

FIG. 5C is a detailed view of a part of the suppressor of FIG. 5A.

FIG. 5D is a cross-section view of the suppressor of FIG. 5A.

FIG. 5E is a detailed view of a part of the suppressor of FIG. 5D.

FIG. 6A is a side view of a suppressor that has a granular aggregate layer over a mesh layer over a first coating layer over its surface.

FIG. 6B is a side section view of the suppressor of FIG. 6A.

FIG. 6C is a detailed view of a part of the suppressor of FIG. 6A.

FIG. 6D is a cross-section view of the suppressor of FIG. 6A.

FIG. 6E is a detailed view of a part of the suppressor of FIG. 6D.

FIG. 7A is a side view of a suppressor that has a second coat layer over a granular aggregate layer over the mesh layer over a first coating layer over its surface.

FIG. 7B is a side section view of the suppressor of FIG. 7A.

FIG. 7C is a detailed view of a part of the suppressor of FIG. 7A.

FIG. 7D is a cross-section view of the suppressor of FIG. 7A.

FIG. 7E is a detailed view of a part of the suppressor of FIG. 7D.

FIG. 8 is a side-view of a suppressor showing different stages of the application process.

FIG. 9 is a cross-section view of a suppressor showing different stages of the application process.

FIG. 10 is a flow chart showing an embodiment of the method.

FIG. 11A shows a side view of a suppressor that has only the base surface.

FIG. 11B is a side section view of the suppressor of FIG. 11A.

FIG. 11C is a detailed view of a part of the suppressor of FIG. 11A.

FIG. 11D is a cross-section view of the suppressor of FIG. 11A.

FIG. 11E is a detailed view of a part of the suppressor of FIG. 11D.

FIG. 12A shows a side view of a suppressor that has a first coating layer applied over the base surface.

FIG. 12B is a side section view of the suppressor of FIG. 12A.

FIG. 12C is a detailed view of a part of the suppressor of FIG. 12A.

FIG. 12D is a cross-section view of the suppressor of FIG. 12A.

FIG. 12E is a detailed view of a part of the suppressor of FIG. 12D.

FIG. 13A shows a side view of a suppressor that has a reinforcement layer over a first coating layer applied over the base surface.

FIG. 13B is a side section view of the suppressor of FIG. 13A.

FIG. 13C is a detailed view of a part of the suppressor of FIG. 13A.

FIG. 13D is a cross-section view of the suppressor of FIG. 13A.

FIG. 13E is a detailed view of a part of the suppressor of FIG. 13D.

FIG. 14A shows a side view of a suppressor that has a second coating layer over a reinforcement layer over a first coating layer applied over the base surface.

FIG. 14B is a side section view of the suppressor of FIG. 14A.

FIG. 14C is a detailed view of a part of the suppressor of FIG. 14A.

FIG. 14D is a cross-section view of the suppressor of FIG. 14A.

FIG. 14E is a detailed view of a part of the suppressor of FIG. 14D.

FIG. 15A shows a side view of a suppressor that has a granular aggregate layer applied over a second coating layer over a reinforcement layer over a first coating layer applied over the base surface.

FIG. 15B is a side section view of the suppressor of FIG. 15A.

FIG. 15C is a detailed view of a part of the suppressor of FIG. 15A.

FIG. 15D is a cross-section view of the suppressor of FIG. 15A.

FIG. 15E is a detailed view of a part of the suppressor of FIG. 15D.

FIG. 16A shows a side view of a suppressor that has an outermost coating layer applied over a granular aggregate layer applied over a second coating layer over a reinforcement layer over a first coating layer applied over the base surface.

FIG. 16B is a side section view of the suppressor of FIG. 16A.

FIG. 16C is a detailed view of a part of the suppressor of FIG. 16A.

FIG. 16D is a cross-section view of the suppressor of FIG. 16A.

FIG. 16E is a detailed view of a part of the suppressor of FIG. 16D.

FIG. 17A is an angled view of a method of manufacture of a suppressor.

FIG. 17B is a side view of a method of manufacture of a suppressor.

FIG. 17C is a partial side-section view of a method of manufacture of a suppressor.

FIG. 17D is a cross-section view of a method of manufacture of a suppressor.

FIG. 17E is a detailed view of a cross-section view of a method of manufacture of a suppressor.

FIG. 18A is a side view of a method of manufacture of a suppressor.

FIG. 18B is a side view of a method of manufacture of a suppressor

### DETAILED DESCRIPTION OF DRAWINGS

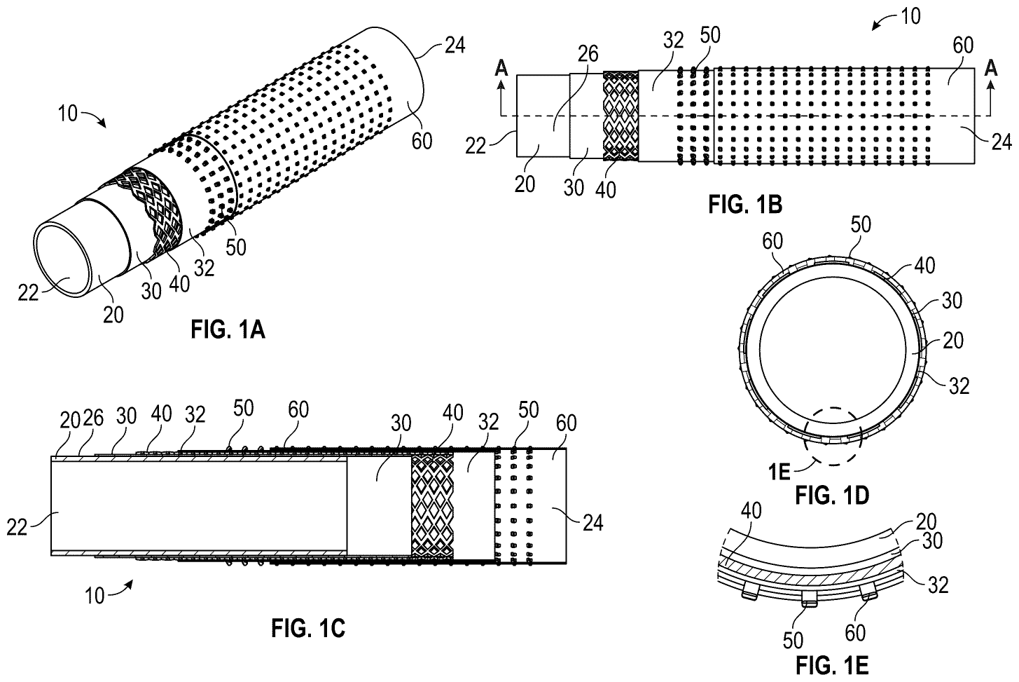

FIG. 1A through 1E show various views of a method of manufacturing a firearm component, in this embodiment a suppressor 10. FIG. 1A shows an angled view, FIG. 1B shows a side view, FIG. 1C shows a partial side-section view of section A-A of FIG. 1B, FIG. 1D shows a cross-section view, and FIG. 1E shows a detailed view of portion 1E of FIG. 1D. The suppressor has a body 20 with first end 22 and second end 24 with an exterior surface 26 along its entire length. A first coating layer 30 is applied to the exterior surface, followed by applying a reinforcement layer 40 external to the coating layer. An additional coating layer 32 is applied over the reinforcement layer. Granular aggregate 50 is then applied. A final, externalmost coating layer 60 is applied last and encompasses the aggregate component to act as a filler between individual pieces.

For purposes of demonstrating the method of manufacture, the internal components of the suppressor 10, such as baffles or other sound suppressing qualities, or attachment points, or end accessories, are not shown in any of the figures.

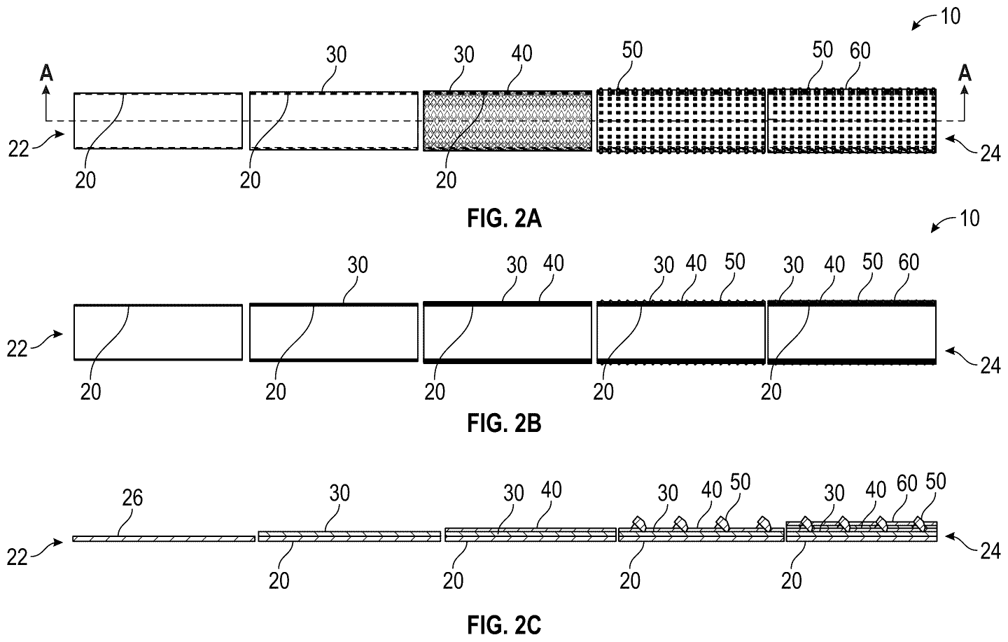

FIGS. 2A through 2C show an embodiment of a method of manufacturing a firearm component, in this embodiment a suppressor 10, with the stages depicted as distinct sections. FIG. 2A is a side view of the stages, FIG. 2B is a side section view of the same stages, and FIG. 2C is a close-up view of the layers of the suppressor at the different stages. The suppressor has a body 20 with a first end 22 and a second end 24, with a continuous surface 26 from the first end to the second end, with the gaps in these drawings present only for emphasis between stages of layer application. The section at the first end shows a bare exterior surface 26 of the suppressor body 20. The adjacent section to the right shows a first coating layer 30 applied to the exterior surface. The next adjacent section to the right shows the addition of a reinforcement layer 40 applied over the first coating layer. The next section to the right shows the application of a layer comprising individual pieces of aggregate 50. The final section at the second end 24 shows a second coating layer 60 filling the spaces between the individual aggregate pieces 50 while still allowing the aggregate pieces to protrude beyond the second coating layer. FIG. 2B shows how the externalmost coating layer 60 covers the aggregate pieces 50 to a greater degree than the adjacent preceding section depicts but does not completely cover the aggregate with the tips protruding. This is also exemplified in FIG. 2C with the layer 60 clearly depicted.

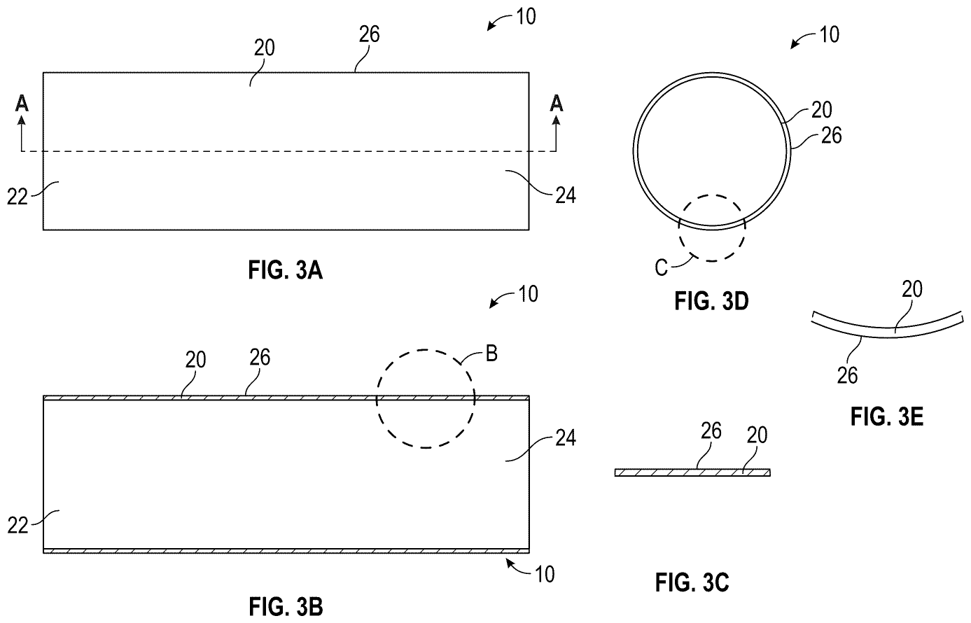

FIGS. 3A through 3E show the beginning of every embodiment of the method of manufacturing a firearm component, in this embodiment a suppressor 10, beginning with a suppressor has a body 20 with an exterior surface 26. FIG. 3A shows a side view with side section view A-A shown in FIG. 3B. A detailed view of section B of FIG. 3B is shown in FIG. 3C. FIG. 3D shows a cross-section view of the suppressor body 20 and exterior surface 26, with FIG. 3E being a detailed view of a portion C.

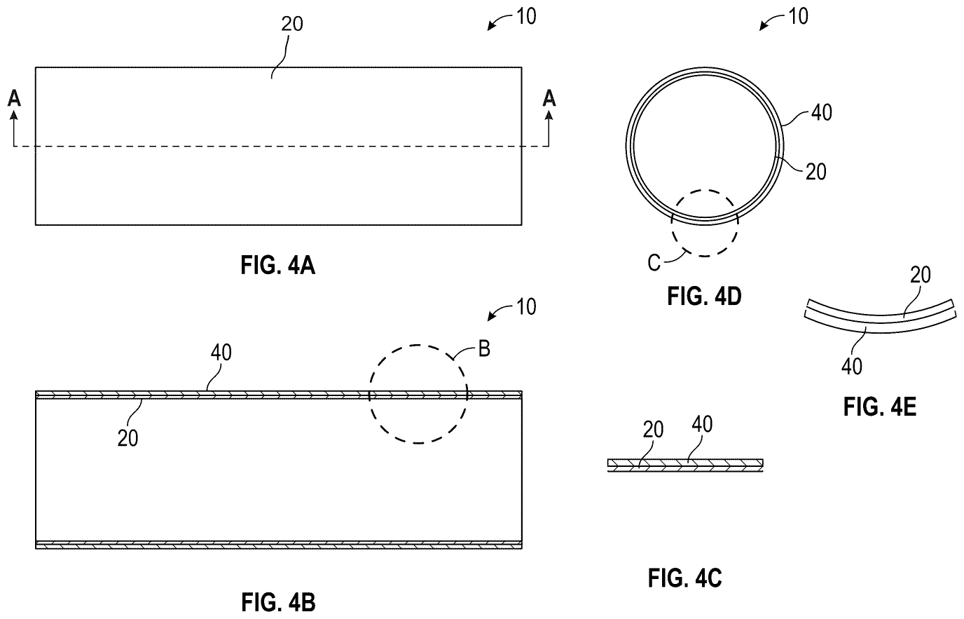

FIGS. 4A through 4E, 5A through 5E, 6A through 6E, and 7A through 7E show steps in another embodiment of manufacturing a firearm component, in this embodiment a suppressor 10 where a reinforcement layer 40 is applied first to the suppressor body surface.

FIGS. 4A through 4E show the first step with a suppressor 10 with a body 20 having a reinforcement layer 40, in this embodiment a mesh, applied over the exterior surface 26 (previously identified in FIGS. 3A-3E). FIG. 4A shows a side view with side section view A-A shown in FIG. 4B depicting the reinforcement layer 40 over the body. A detailed view of a section B of FIG. 4B is shown in FIG. 4C where the body and first coating layer 30 can be seen in greater contrast. FIG. 4D shows a cross-section view of the suppressor body 20 and exterior surface 26 (previously identified in FIGS. 3D) and reinforcement layer 40, with FIG. 4E being a detailed view of a section C.

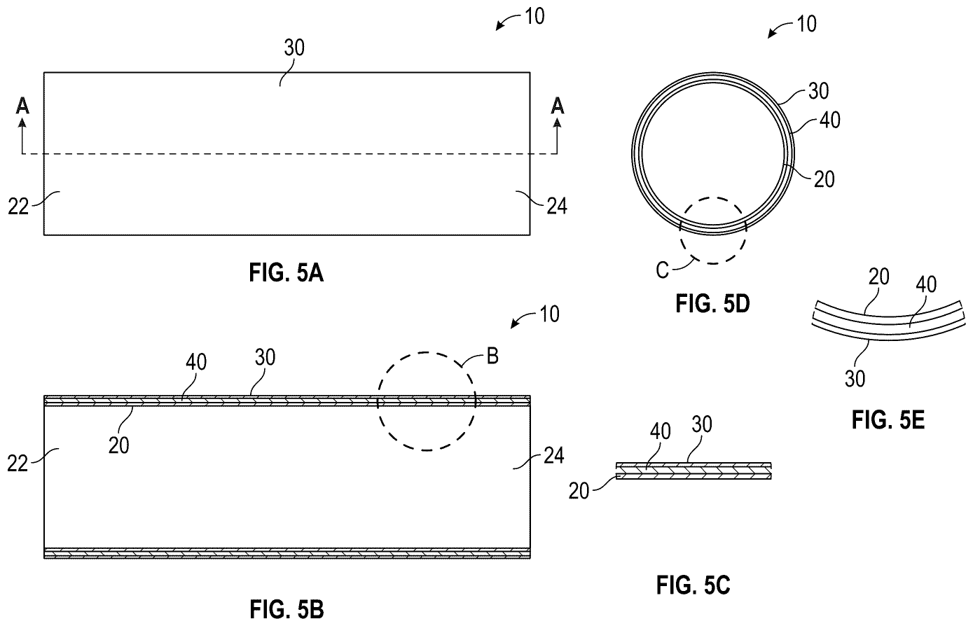

FIGS. 5A through 5E show the second step with a suppressor 10 with a body 20 with a reinforcement layer 40, in this embodiment a mesh, applied over the exterior surface 26 (previously identified in FIGS. 3A-3E) of the body. A first coating layer 30 is applied over the mesh and completely covers the mesh. FIG. 5A shows a side view with side section view A-A shown in FIG. 5B depicting the reinforcement layer 40 over the body with a first coating layer 30 as the external most layer at this stage. A detailed view of a section B of FIG. 5B is shown in FIG. 4C where the body, reinforcement layer 40, and first coating layer 30 can be seen in greater contrast. FIG. 5D shows a cross section view of the suppressor body 20 and exterior surface 26 and reinforcement layer 40, with FIG. 5E being a detailed view of a section C.

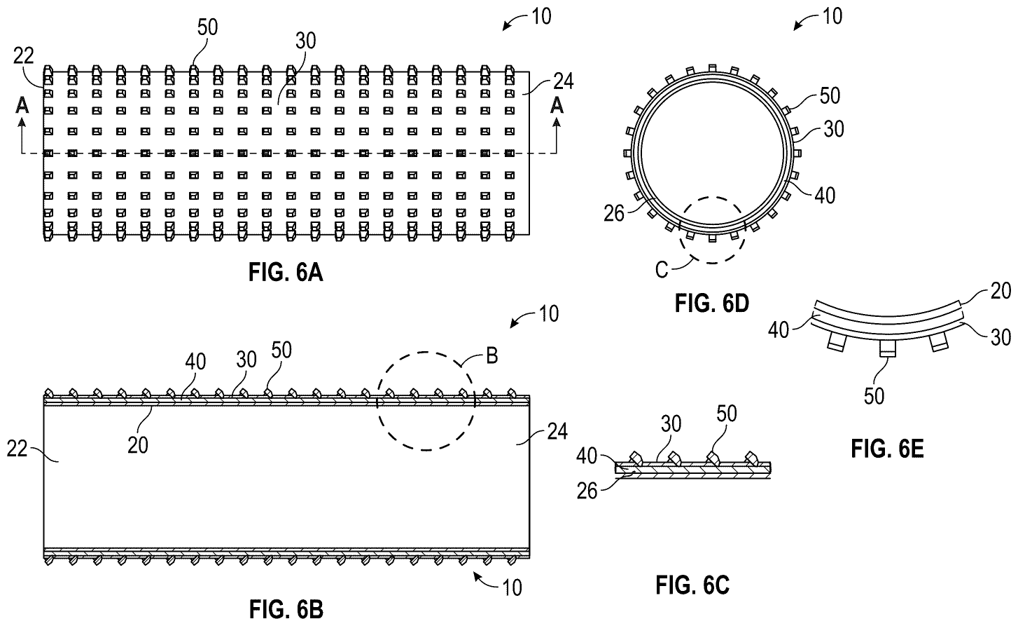

FIGS. 6A through 6E show a third step where aggregate pieces 50 are applied over the coating layer 30 covering the reinforcement layer 40 applied over the exterior surface 26 (previously identified in FIGS. 3A-3E) of the body 20. FIG. 6A shows a side view with side section view A-A shown in FIG. 6B depicting the reinforcement layer 40 over the body with a first coating layer 30 covering the reinforcement layer and aggregate 50 being the external most layer. A detailed view of section B of FIG. 6B is shown in FIG. 6C where the exterior surface 26, reinforcement layer 40, and first coating layer 30, and aggregate 50 can be seen in greater contrast. The aggregate can be seen partially within the first coating layer with the majority of the aggregate being above the first coating layer in FIG. 6C. FIG. 6D shows a cross-section view of an embodiment of the suppressor 10 and where the aggregate 50 is completely on the surface of the first coating layer 30 over reinforcement layer 40 overlaying the exterior surface 26, with FIG. 6E being a detailed view of a section C.

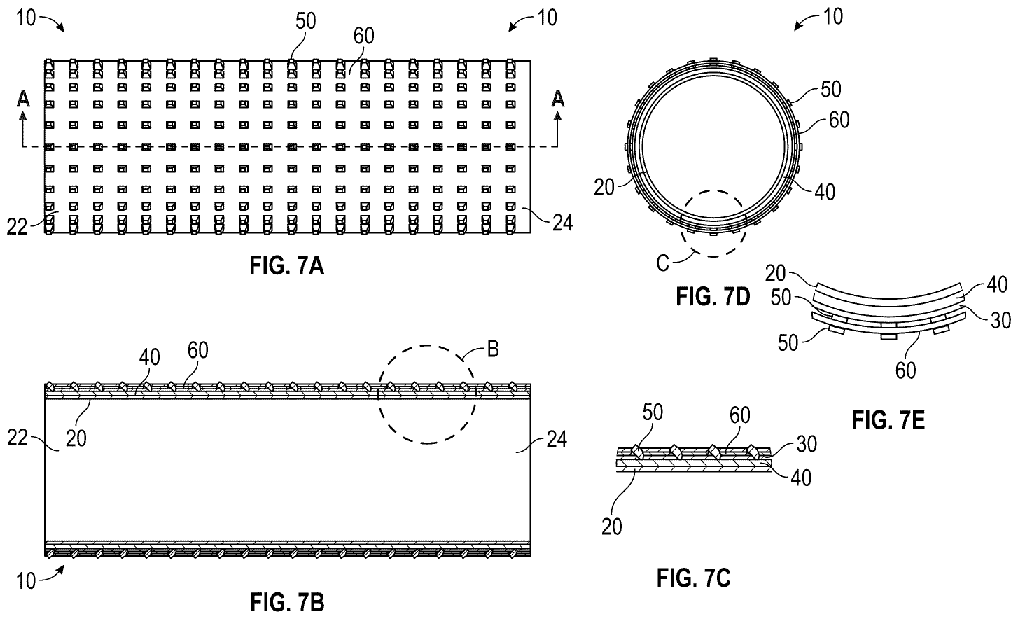

FIGS. 7A through 7E show the final step a final coating layer 60 is applied after the aggregate pieces 50 are applied to a first coating layer 30 covering a reinforcement layer 40 on the surface 26 of the body 20 of a suppressor 10. FIG. 7A shows a side view with side section view A-A shown in FIG. 7B depicting the reinforcement layer 40 over the exterior surface 26 with a first coating layer 30 submerging the reinforcement layer completely and a second coating layer 60 applied over the aggregate 50. A detailed view of a section B of FIG. 7B is shown in FIG. 7C where the exterior surface 26, reinforcement layer 40, and first coating layer 30, aggregate 50, and second coating layer 60 can be seen in greater contrast. The aggregate can be seen partially within the first coating layer with the majority of the aggregate being above the first coating layer. FIG. 7D shows a cross-section view of an embodiment of the suppressor 10 and where the aggregate 50 is submerged, though not entirely, by the second coat layer 60, with FIG. 7E being a detailed view of a section C.

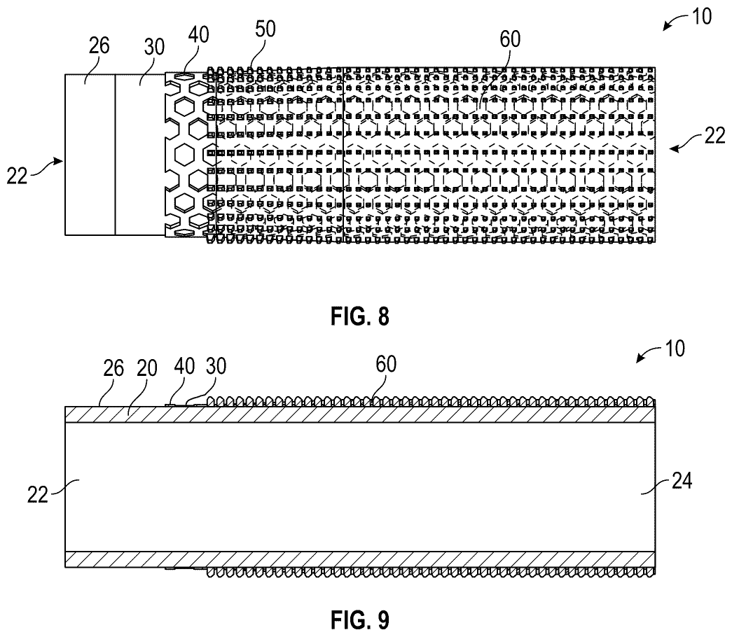

FIG. 8 shows a side view of the various stages of layer application for the method of manufacturing a firearm component, in this embodiment a suppressor 10. The first end 22 has an exterior surface 26 with no layers applied, with a first coating layer 30 applied to the right, followed by a reinforcement layer 40 over the first coating layer. The remainder of the suppressor going towards the second end 24 shows aggregate 50 over and within a second coating layer 30. In the reinforcement layer was applied over the first coating layer so as to not be encompassed by the first coating layer, and the second coating layer being of necessary quantity where the underlying reinforcement layer is still distinguishable.

FIG. 9 shows a cross-section view of the steps of an embodiment of manufacturing a firearm component, in this embodiment a suppressor 10 having a body 20 with a first end 22, second end 24, and surface 26, where a reinforcement layer 40 is applied first before a coating layer 30, followed by aggregate pieces 50 and a final coating layer 60 applied to fill the spaces between the individual pieces. The progression of steps of applications is viewed from the first end, which show the surface with no layers applied, towards the second end where all layers have been applied.

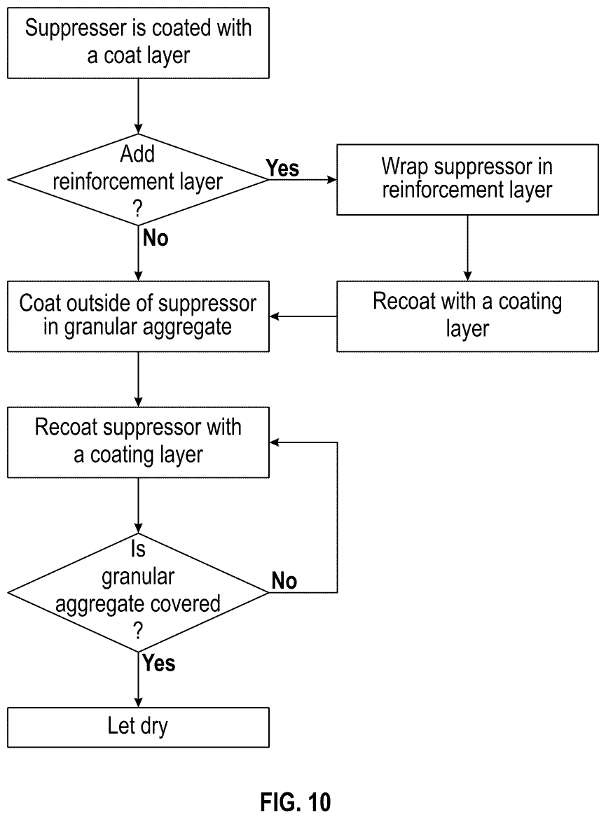

FIG. 10 shows a flow chart of another embodiment of the method of manufacturing a firearm component, in this embodiment a suppressor, has various stages of layer application. A suppressor is coated with a first coat layer. If a reinforcement layer is to be added, the suppressor is wrapped in a reinforcement layer, after the first coating layer is applied. The suppressor with the reinforcement layer is then coated again, either with the same coating material or composition as the first coating layer, or a different coating material. The suppressor is then coated with granular aggregate. If no reinforcement layer is added, the granular aggregate is applied directly after the first coating layer. This coating layer may be the same material or composition as the first coating layer or a different coating material. If the granular aggregate is covered by the coating layer to a desired amount, the suppressor is left to dry. If the aggregate is not sufficiently covered by a coating layer, the suppressor has a coating layer reapplied.

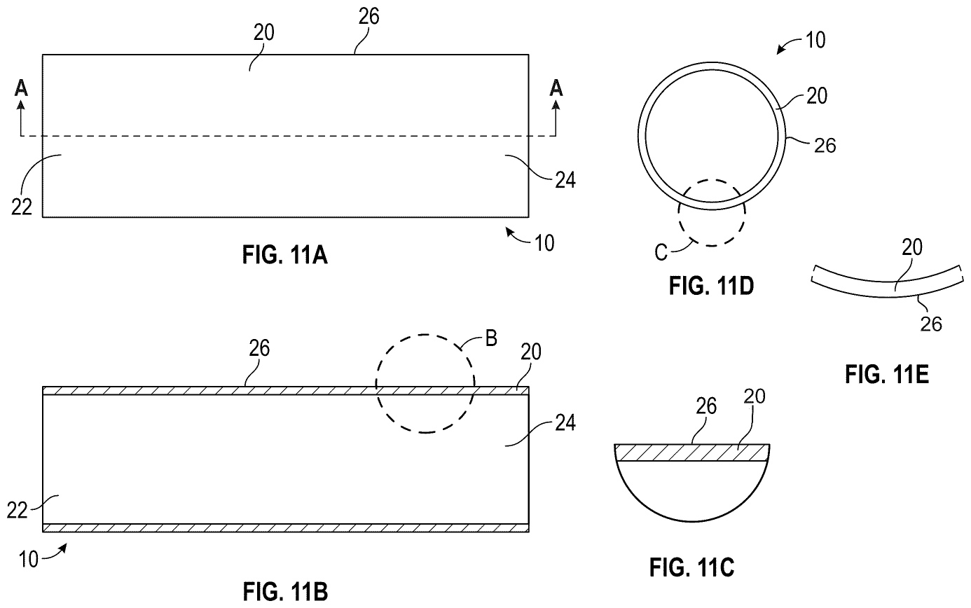

FIGS. 11A through 11E, 12A through 12E, 13A through 13E, 14A through 14E, 15A through 15E, and 16A through 16E show various views of the stages for a method of manufacturing a firearm component, in this embodiment a suppressor 10 having a body 20 with a first end 22, second end 24, and surface 26.

FIGS. 11A through 11E shows various views of a method of manufacturing a firearm component, in this embodiment a suppressor 10 beginning with a body 20 with a first end 22, second end 24, and surface 26. FIG. 11A is a side view, FIG. 11B is a side section view of section A-A of FIG. 11A, FIG. 11C is a detailed view of portion B of FIG. 11B, FIG. 11D is a cross-section view, and FIG. 11E is a detailed view of portion C of FIG. 11D.

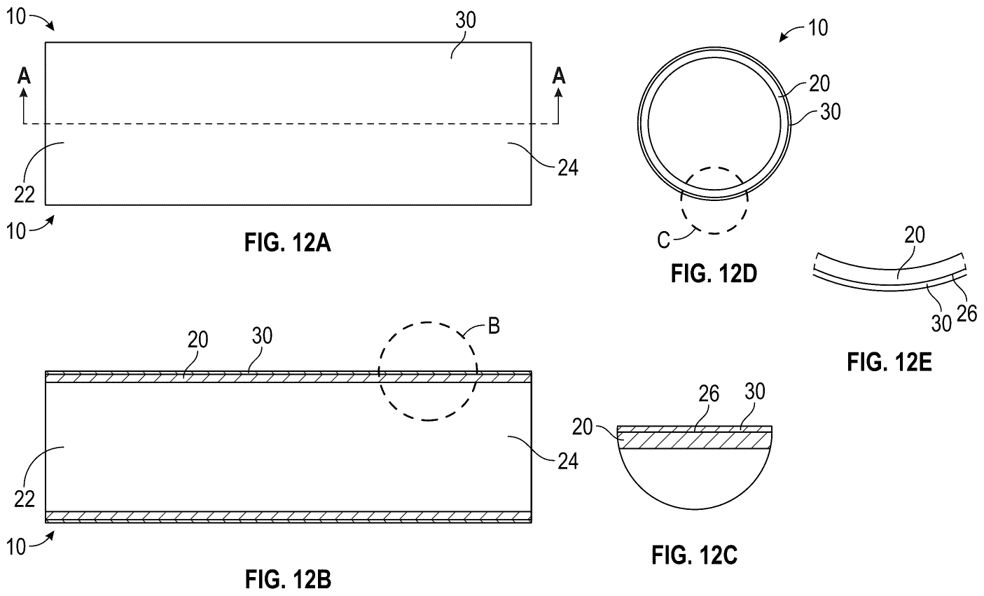

FIGS. 12A through 12E shows various views of the first step method of manufacturing a firearm component, in this embodiment a suppressor 10. A first coating layer 30 is applied over the body 20 of the suppressor. FIG. 12A is a side view, FIG. 12B is a side section view of section A-A of FIG. 12A, FIG. 12C is a detailed view of portion B of FIG. 12B, FIG. 12D is a cross-section view, and FIG. 12E is a detailed view of portion C of FIG. 12D.

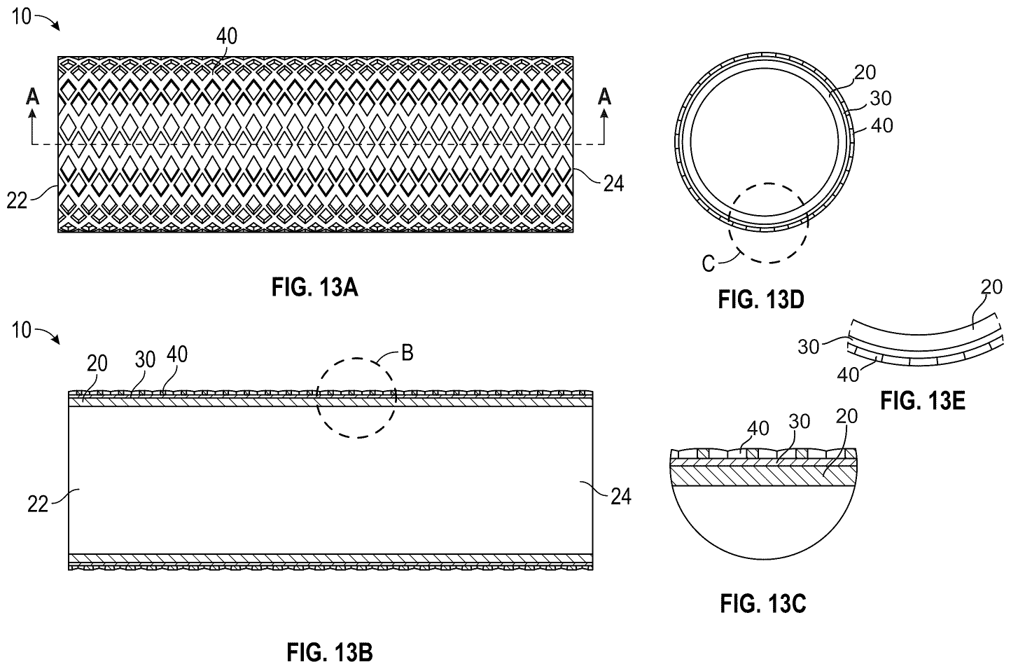

FIGS. 13A through 13E shows various views of the second step method of manufacturing a firearm component, in this embodiment a suppressor 10. A reinforcement layer 40 is applied over the first coating layer 30 that is applied over the body 20 of the suppressor. FIG. 13A is a side view, FIG. 13B is a side section view of section A-A of FIG. 13A, FIG. 13C is a detailed view of portion B of FIG. 13B, FIG. 13D is a cross-section view, and FIG. 13E is a detailed view of portion C of FIG. 13D.

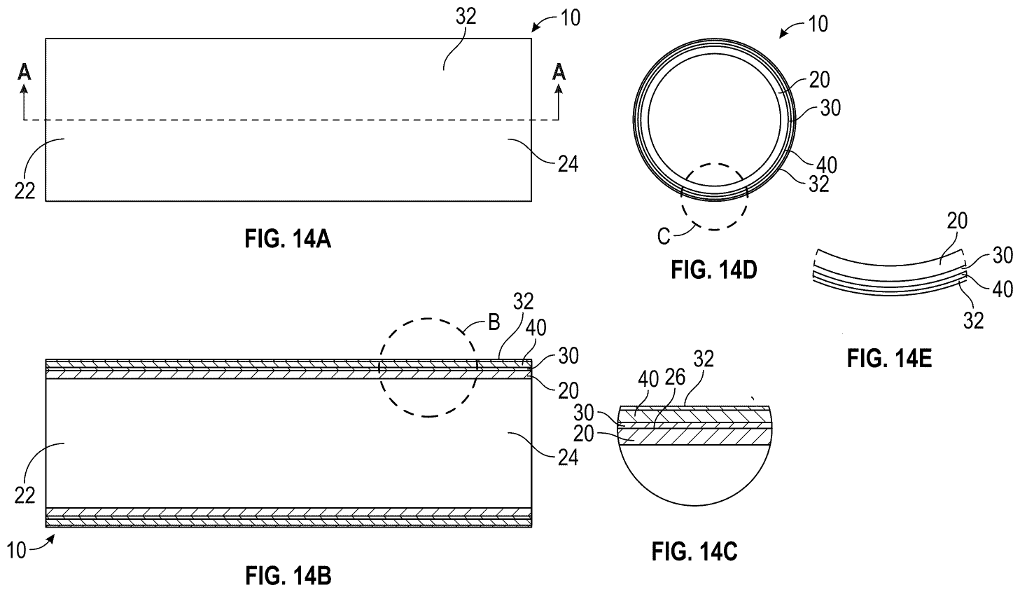

FIGS. 14A through 14E shows various views of the third step in the method of manufacturing a firearm component, in this embodiment a suppressor 10. A second coating layer 32 is applied over the reinforcement layer 40 that is applied over the first coating layer 30 covering the body 20 of the suppressor. FIG. 14A is a side view, FIG. 14B is a side section view of section A-A of FIG. 14A, FIG. 14C is a detailed view of portion B of FIG. 14B, FIG. 14D is a cross-section view, and FIG. 14E is a detailed view of portion C of FIG. 14D.

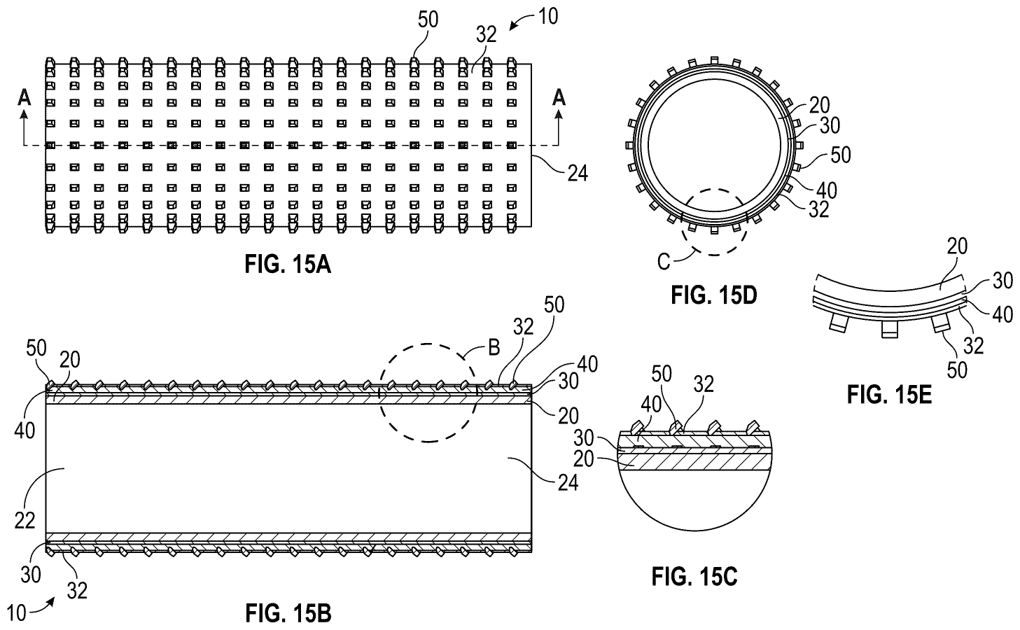

FIGS. 15A through 15E shows various views of the fourth step in the method of manufacturing a firearm component, in this embodiment a suppressor 10. A granular aggregate 50 is applied over the second coating layer 32 covering the reinforcement layer 40 applied over the first coating layer 30 covering the body 20 of the suppressor. FIG. 15A is a side view, FIG. 15B is a side section view of section A-A of FIG. 15A, FIG. 15C is a detailed view of portion B of FIG. 15B, FIG. 15D is a cross-section view, and FIG. 15E is a detailed view of portion C of FIG. 15D.

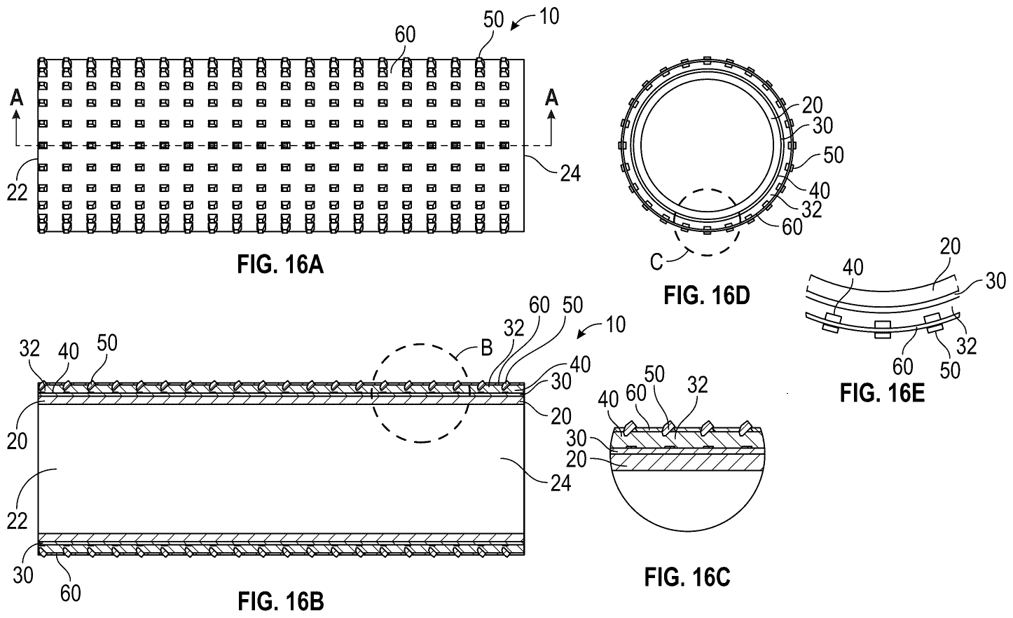

FIGS. 16A through 16E shows various views of the final step in the method of manufacturing a firearm component, in this embodiment a suppressor 10. A final, externalmost coating layer 60 is applied over the granular aggregate 50 from the previous step so as to fille the spaces between the aggregate. In this embodiment the layer 60 does not completely cover the aggregate but in other embodiments it may. FIG. 16A is a side view, FIG. 16B is a side section view of section A-A of FIG. 16A, FIG. 16C is a detailed view of portion B of FIG. 16B, FIG. 16D is a cross-section view, and FIG. 16E is a detailed view of portion C of FIG. 16D.

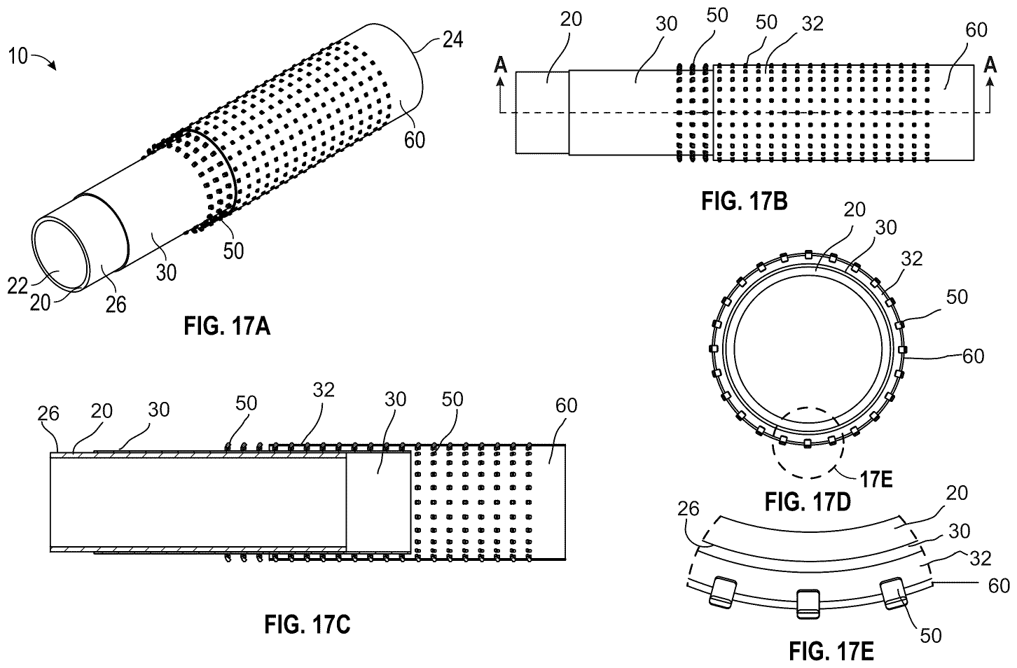

FIGS. 17A through 17E shows various views of another embodiment of a method of manufacturing a firearm component, in this embodiment a suppressor 10 beginning with a suppressor body 20 with a first end 22, second end 24, and surface 26. In this embodiment there is no application of a reinforcement layer, and the method includes applying a first coating layer 30 over the surface 26 followed by the application of granular aggregate 50 and a final application of another coating layer 60. FIG. 17A is a side view, FIG. 17B is a side section view of section A-A of FIG. 17A, FIG. 17C is a detailed view of portion B of FIG. 17B, FIG. 17D is a cross-section view, and FIG. 17E is a detailed view of portion C of FIG. 17D.

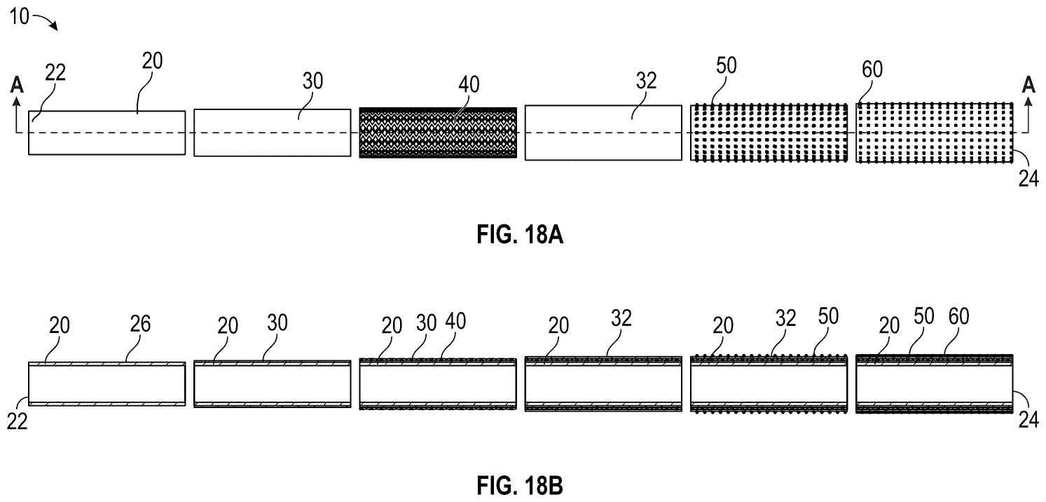

FIGS. 18A shows the steps of the method of manufacturing a firearm component, in this embodiment a suppressor 10 having a body 20 first end 22, a second end 24, and surface 26. The different steps are conveyed by sectioning the suppressor into distinct segments with a gap in between them for emphasis purposes to make clear each step distinct from adjacent steps. At the first end 22 the method begins with a suppressor body having a surface. Progressing towards the second end, the first step includes the application of a first coating layer 30 over the surface. The next step is the application of a reinforcement layer 40, followed by a second coating layer 32, granular grit 50, and a final coating layer 60, shown at the second end 24. FIG. 18B shows a side-section view of FIG. 18A.

With respect to the multiple coating layers, such as the first coating layer 30, second coating layer 32, and externalmost coating layer 60, the coating layers may be of the same composition and type or may be distinct from one or more other layers.

In certain embodiments the first coating layer 30 or second coating layer may be a substance such as, but not limited to, paint, Cerakote®, an epoxy, or a ceramic. The reinforcement layer 40 may be in certain embodiments a mesh, and composed of materials such as, but not limited to, wrap filament, felt, or heat insulating cloth. In certain embodiments the reinforcement layer may be selected from materials including, but not limited to, woven sheets, perforated sheets, non-woven sheets, felts, carbon fiber, fiberglass, Nomex®, Nextel™, or ceramic.

In certain embodiments where a reinforcement layer 40 is used, the layer becomes saturated and covered completely by the second coating layer 60. Utilizing the reinforcement layer 40 reinforces the second coating and helps prevent the first coating layer 30 from becoming brittle and cracking.

The aggregate 50 may be a granular aggregate in some embodiments. In certain embodiments, the degree of embedding of the granular aggregate within the first coating layer 30 may include has the granular aggregate fully embedded. In other embodiments the granular aggregate may be only partially embedded in the first coating layer and the exposed portion of the granular aggregate may be covered by a second coating layer 60 to further partially or completely embed the granular aggregate as shown in FIG. 7C.

The embodiment shown of the method for creating suppressor 10 with a second coating layer 60 that forms the external surface has granular aggregate 50 includes starting with a suppressor has body 20 a clean exterior surface 26. In one embodiment the surface is prepared for a layer of either a first coat 30 or reinforcement layer 40 by blasting with an 80 grit media. In other embodiments of the method other methods of preparation of a metal surface for coating may be implemented. Contaminants are then removed by blowing the surface with dry air, with superior results being obtained using air cleaned by filtration. A first coating layer 30 is applied to the surface and the coating is allowed to flash dry. The suppressor is then wrapped with a reinforcement layer 40 and then sprayed with a heavy coat of second coating layer 60. While the second coating layer is still wet, grit aggregate 50, such as a combination of 80 and 220 grit, is broadcasted to become embedded into the first coating layer. The subsequent second coating layer 60 is then flash dried, holding the aggregate to the suppressor. Additional coats of paint may further be applied to increase encapsulation of the aggregate to the suppressor. As the first coating layer, and any subsequent coats, dries and shrinks the aggregate is partially exposed. This results in a substantially similar process and layering as shown in FIG. 7C, with the only difference being if the second coating layer is applied before or after the aggregate is applied. FIG. 7C could also be viewed as has the second coating layer applied over the reinforcement layer and the aggregate forced into the second coating layer.

The aggregate 44 may include different materials and sizes tailor the resulting surface for different applications. Materials for the aggregate may be granular and may include but are not limited to garnet, aluminum oxide, glass, pumice, ceramic, and silica. The size of granular aggregate may include, but is not limited to, 40 grit astm, 0.018″, 60 grit astm, 0.010″, 80 grit astm, 0.007″, 120 grit astm, 0.005″, or 220+grit astm, 0.0025″.

In the current embodiment shown of the method for creating the suppressor 10 with a second coating 60 that forms the external surface has granular aggregate 50, the granular aggregate is applied by broadcasting. Other application processes may be utilized in other embodiments, including but not limited to rolling the granular aggregate onto a coating layer or dipping the suppressor with at least one coating layer into granular aggregate.

An embodiment of the method of manufacturing a firearm component comprises of providing a body has an exterior surface, applying a first coating layer to the exterior surface and after coating the exterior surface, affixing a granular aggregate to the exterior surface. After affixing the aggregate, an additional coating layer is applied. Applying one of the first or additional coating layers includes applying a ceramic material. Affixing the aggregate includes affixing the aggregate a limited time after applying the first coating layer and adhering the aggregate to the first coating layer before the first coating layer is dried. The method may also include wrapping a mesh about the body, wherein the mesh is selected from materials including but not limited to woven sheets, perforated sheets, non-woven sheets, felts, carbon fiber, fiberglass, Nomex™, Nextel™, and ceramic. At least one additional coating layer may be applied after applying the mesh, and before affixing the aggregate. Affixing the aggregate is selected from steps including sprinkling the aggregate, dipping in the aggregate, and fluidized bed coating. The aggregate is selected from materials including but not limited to Garnet, Aluminum Oxide, Glass, Pumice, Ceramic and Silica. The component may be a firearm suppressor tube, the suppressor comprising a tube has an exterior surface, a first coating layer on the exterior surface, a granular aggregate embedded in the first coating layer; and an additional coating layer at least in part overlaying the granular aggregate. The firearm suppressor has the coating as a ceramic material, and optionally includes a mesh wrapped about the body. The mesh may be selected from materials including but not limited to woven sheets, perforated sheets, non-woven sheets, felts, carbon fiber, fiberglass, Nomex, Nextel, and ceramic. The mesh may underlie the aggregate. The suppressor may have an additional coating layer between the mesh and the aggregate. The aggregate may be selected from materials including but not limited to Garnet, Aluminum Oxide, Glass, Pumice, Ceramic and Silica.

I claim:

1. A method of manufacturing a firearm component comprising:
providing a body has an exterior surface;
applying a first coating layer to the exterior surface;
after coating the exterior surface, affixing a granular aggregate to the exterior surface; and
after affixing the aggregate, applying an additional coating layer.

2. The method of claim 1 wherein applying one of the first or additional coating layers includes applying a ceramic material.

3. The method of claim 1 wherein affixing the aggregate includes affixing the aggregate a limited time after applying the first coating layer and adhering the aggregate to the first coating layer before the first coating layer is dried.

4. The method of claim 1 including wrapping a mesh about the body.

5. The method of claim 4 wherein the mesh is selected from materials including woven sheets, perforated sheets, non-woven sheets, felts, carbon fiber, fiberglass, Nomex, Nextel, and ceramic.

6. The method of claim 4 including applying an additional coating layer after applying the mesh, and before affixing the aggregate.

7. The method of claim 1 wherein affixing the aggregate is selected from steps including sprinkling the aggregate, dipping in the aggregate, and fluidized bed coating.

8. The method of claim 1 wherein the aggregate is selected from materials including Garnet, Aluminum Oxide, Glass, Pumice, Ceramic and Silica.

9. The method of claim 1 wherein the component is a firearm suppressor tube.

10. A firearm suppressor comprising:
a tube has an exterior surface;
a first coating layer on the exterior surface;
a granular aggregate embedded in the first coating layer; and
an additional coating layer at least in part overlaying the granular aggregate.

11. The firearm suppressor of claim 10 wherein the coating is a ceramic material.

12. The firearm suppressor of claim 10 including a mesh wrapped about the body.

13. The firearm suppressor of claim 12 wherein the mesh is selected from materials including woven sheets, perforated sheets, non-woven sheets, felts, carbon fiber, fiberglass, Nomex, Nextel, and ceramic.

14. The firearm suppressor of claim 12 wherein the mesh underlies the aggregate.

15. The firearm suppressor of claim 12 including an additional coating layer between the mesh and the aggregate.

16. The firearm suppressor of claim 12 wherein the aggregate is selected from materials including Garnet, Aluminum Oxide, Glass, Pumice, Ceramic and Silica.
